(19) United States
(12) Patent Application Publication
(10) Pub. No.: US 2026/0362344 A1
(43) Pub. Date: Nov. 12, 2026

(54) TRIGGERING A POWER HEADROOM REPORT FOR SOUNDING REFERENCE SIGNAL TRANSMISSION

(71) Applicant: Lenovo (United States) Inc., Morrisville, NC (US)

(72) Inventor: Colin Frank, Park Ridge, IL (US)

(73) Assignee: Lenovo (United States) Inc., Morrisville, NC (US)

(21) Appl. No.: 19/203,111

(22) Filed: May 8, 2025

(51) Int. Cl. H04W 52/36

(52) U.S. Cl. CPC H04W 52/365

(57) ABSTRACT

Various aspects of the present disclosure relate to triggering a power headroom report for sounding reference signal (SRS) transmission. A user equipment (UE) may transmit a power headroom report based on a transmit power associated with an SRS port of a set of SRS ports satisfying a transmit power threshold. The transmit power threshold is based on a maximum transmit power associated with the SRS port. The SRS port has a smallest insertion loss of respective insertion losses associated with the set of SRS ports. The UE may transmit one or more SRSs to a network equipment (NE) using the plurality of SRS ports based on the power headroom report. The NE may obtain a channel estimation using the SRSs.

### TECHNICAL FIELD

The present disclosure relates to wireless communications, and more specifically to transmit power management for reference signal transmissions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to transmit a power headroom report based on a transmit power associated with an SRS port of a set of SRS ports (e.g., a reference SRS port, port 1) satisfying a transmit power threshold, where the transmit power threshold is based on a maximum transmit power (e.g., also referred to as a configured maximum transmit power) associated with the SRS port, and where the SRS port has a smallest insertion loss of respective insertion losses associated with the plurality of SRS ports, and transmit, based on the power headroom report, one or more SRSs using the set of SRS ports.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the plurality of SRS ports, and transmit, based on the power headroom report, one or more SRSs using the set of SRS ports.

A method performed or performable by a UE for wireless communication is described. The method may include transmitting a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the plurality of SRS ports, and transmitting, based on the power headroom report, one or more SRSs using the set of SRS ports.

In some implementations of the UE, the processor, and the method described herein, respective transmit powers associated with the set of SRS ports correspond to respective differences in insertion losses between the SRS port and respective additional SRS ports of the set of SRS ports up to respective maximum transmit powers associated with the set of SRS ports, where the power headroom report includes a power headroom associated with the SRS port. In some implementations of the UE, the processor, and the method described herein, the transmit power threshold is based on an additional SRS port of the set of SRS ports, where the additional SRS port is associated with a largest insertion loss of the respective insertion losses associated with the set of SRS ports. In some implementations of the UE, the processor, and the method described herein, the UE, the processor, and the method may further be configured to, capable of, or operable to transmit, prior to the power headroom report, signaling that indicates at least one of first respective differences in insertion loss between the set of SRS ports or second respective differences in insertion losses corresponding to the set of SRS ports relative to the SRS port.

In some implementations of the UE, the processor, and the method described herein, the UE, the processor, and the method may further be configured to, capable of, or operable to receive, prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. In some implementations of the UE, the processor, and the method described herein, to transmit the power headroom report, the UE, the processor, and the method may further be configured to, capable of, or operable to transmit signaling including the power headroom report for the SRS port and additional information including the maximum transmit power associated with the SRS port. In some implementations of the UE, the processor, and the method described herein, to transmit the power headroom report, the UE, the processor, and the method may further be configured to, capable of, or operable to transmit, in an uplink control channel, dedicated signaling including the power headroom report.

In some implementations of the UE, the processor, and the method described herein, the UE, the processor, and the method may further be configured to, capable of, or operable to apply respective transmit powers associated with one or more SRS ports of the set of SRS ports to the one or more SRSs transmitted using the one or more SRS ports, where the respective transmit powers associated with the one or more SRS ports include values up to respective maximum transmit powers associated with the one or more SRS ports and apply respective maximum transmit powers associated with one or more remaining SRS ports of the set of SRS ports to the one or more SRSs transmitted using the one or more remaining SRS ports based on respective transmit powers associated with the one or more remaining SRS ports exceeding the respective maximum transmit powers associated with the one or more remaining SRS ports. In some implementations of the UE, the processor, and the method described herein, an estimation of a channel corresponding to the one or more SRSs is based on applying at least one of the respective transmit powers associated with the one or more SRS ports or the respective maximum transmit powers associated with the one or more remaining SRS ports.

An NE (e.g., a base station) for wireless communication is described. The NE may be configured to, capable of, or operable to perform one or more operations as described herein. For example, the NE may be configured to, capable of, or operable to receive a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports and receive, based on the power headroom report, one or more SRSs corresponding to the plurality of SRS ports.

A processor (e.g., a standalone processor chipset, or a component of an NE) for wireless communication is described. The processor may be configured to, capable of, or operable to perform one or more operations as described herein. For example, the processor may be configured to, capable of, or operable to receive a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports and receive, based on the power headroom report, one or more SRSs corresponding to the plurality of SRS ports.

A method performed or performable by an NE (e.g., a base station) for wireless communication is described. The method may include receiving a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports and receiving, based on the power headroom report, one or more SRSs corresponding to the plurality of SRS ports.

In some implementations of the NE, the processor, and the method described herein, respective transmit powers associated with the set of SRS ports correspond to respective differences in insertion losses between the SRS port and respective additional SRS ports of the set of SRS ports up to respective maximum transmit powers associated with the set of SRS ports, where the power headroom report includes a power headroom associated with the SRS port. In some implementations of the NE, the processor, and the method described herein, the transmit power threshold is based on an additional SRS port of the set of SRS ports, where the additional SRS port is associated with a largest insertion loss of the respective insertion losses associated with the set of SRS ports. In some implementations of the NE, the processor, and the method described herein, the NE, the processor, and the method may further be configured to, capable of, or operable to receive, prior to the power headroom report, signaling that indicates at least one of first respective differences in insertion loss between the set of SRS ports or second respective differences in insertion losses corresponding to the set of SRS ports relative to the SRS port.

In some implementations of the NE, the processor, and the method described herein, the UE, the processor, and the method may further be configured to, capable of, or operable to transmit, to a UE and prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. In some implementations of the NE, the processor, and the method described herein, to receive the power headroom report, the NE, the processor, and the method may further be configured to, capable of, or operable to receive signaling including the power headroom report for the SRS port and additional information including the maximum transmit power associated with the SRS port. In some implementations of the NE, the processor, and the method described herein, to transmit the power headroom report, the NE, the processor, and the method may further be configured to, capable of, or operable to receive, in an uplink control channel, dedicated signaling including the power headroom report.

In some implementations of the NE, the processor, and the method described herein, the NE, the processor, and the method may further be configured to, capable of, or operable to determine, based on the power headroom report, respective transmit powers associated with one or more SRS ports of the set of SRS ports applied to the one or more SRSs transmitted using the one or more SRS ports of the set of SRS ports, where the respective transmit powers associated with the one or more SRS ports include values up to respective maximum transmit powers associated with the one or more SRS ports and determine, based on the power headroom report, respective maximum transmit powers associated with one or more remaining SRS ports of the set of SRS ports are applied to the one or more SRSs transmitted using the one or more remaining SRS ports based on respective transmit powers associated with the one or more remaining SRS ports exceeding the respective maximum transmit powers associated with the one or more remaining SRS ports. In some implementations of the NE, the processor, and the method described herein, the NE, the processor, and the method may further be configured to, capable of, or operable to obtain an estimation of a channel corresponding to the one or more SRSs based on at least one of the respective transmit powers associated with the one or more SRS ports or the respective maximum transmit powers associated with the one or more remaining SRS ports.

### BRIEF DESCRIPTION OF THE DRAWINGS

FIGS. 1 and 2 illustrate examples of wireless communications systems in accordance with aspects of the present disclosure.

FIG. 3 illustrates an example of a transmission architecture, in accordance with aspects of the present disclosure.

FIGS. 4 and 5 illustrate example of power diagrams, in accordance with aspects of the present disclosure.

FIG. 6 illustrates an example of a signaling diagram, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

A wireless communications system may include one or more devices, such as UEs and NEs, that transmit and receive signaling. A UE and an NE may perform time division duplex (TDD) communications, where uplink and downlink transmissions occur at different times on a same frequency band. For the TDD communications, the UE and the NE may perform channel estimations using one or more reference signals, including sounding reference signals (SRSs). For example, the NE can estimate a downlink channel for communications to the UE by performing measurements on SRS transmissions received from the UE on an uplink channel, as the NE may consider the uplink and downlink channels reciprocal. The UE transmits SRSs using one or more antenna ports, which may be referred to as SRS ports. An antenna port is a logical mapping of physical antenna elements or physical antennas at the UE to signals. The UE can include one or more antennas for transmitting signaling (e.g., transmit antennas) and one or more antennas for receiving signaling (e.g., receive antennas). In some cases, the UE may additionally, or alternatively, use the receive antennas for transmitting signaling, such as SRSs.

The receive antennas that are used for transmitting the SRSs may not have a dedicated power amplifier (PA) for adjusting a transmit power from the UE for the SRSs. Thus, the SRS transmissions can experience a relatively large difference in transmit power (e.g., greater than a threshold variation in transmit power) across the different antennas due to losses between the PA and the antennas, which may be referred to as insertion losses. The insertion losses can be different for different antennas, leading to incorrect channel estimation and a corresponding decrease in throughput and increase in latency. To account for the insertion losses, the UE can perform compensation by increasing a transmit power for one or more of the antennas at the PA. The UE can periodically transmit a power headroom report for an SRS port with a lowest insertion loss to an NE. The power headroom report indicates a remaining transmit power for the SRS port, which is a difference between a maximum transmit power for the SRS port and an actual transmit power for the SRS port. A maximum transmit power for the SRS port may additionally, or alternatively, be referred to as a configured maximum transmit power. The NE can compute the transmit power for the remaining SRS ports using the actual transmit power for the SRS port indicated in the power headroom report and fixed insertion loss differences between the SRS ports. However, periodically transmitting the power headroom report may lead to increased signaling overhead and inefficient use of communication resources, as the NE may be able to compute the insertion losses using a single power headroom report until a maximum transmit power for an SRS port is exceeded.

As described herein, to reduce signaling overhead and to improve resource allocation for power headroom reports, a UE may transmit a power headroom report for an SRS port with the lowest insertion loss of the SRS ports at the UE according to a trigger condition. In some cases, the NE can indicate for the UE to transmit the power headroom report if a transmit power of at least one SRS port satisfies a threshold value (e.g., exceeds a configured maximum transmit power for the at least one SRS port). For example, if a transmit power of the SRS port with the lowest insertion loss is greater than a difference between the maximum transmit power of the SRS port and a maximum transmit power difference between the maximum transmit powers of the SRS ports, then the UE can transmit a power headroom report for the SRS port with the lowest insertion loss. The maximum transmit power difference may be a difference in a maximum transmit power between the SRS port with the lowest insertion loss and an SRS port with a greatest insertion loss of the SRS ports at the UE and may also represent a difference in insertion loss between the SRS port with the lowest insertion loss and the SRS port with the greatest insertion loss. In some cases, the UE can transmit signaling to the NE prior to transmitting the power headroom report that indicates respective differences between the insertion losses (e.g., maximum transmit powers) for different SRS ports and/or differences between the insertion losses of respective SRS ports relative to the SRS port with the lowest insertion loss. The UE can transmit the SRSs using the SRS ports, and the NE can estimate the channel using the SRSs and the power headroom report to determine transmit powers for the SRS ports of the UE.

By performing the described techniques, a UE may dynamically report power headroom according to a trigger condition, which reduces signaling overhead and time-frequency resource usage compared to periodically reporting power headroom. Further, the NE may obtain more accurate and timely information about the transmit power at different SRS ports of the UE, enabling improved power control and resource allocation related to channel estimation using the SRSs from the SRS ports. The trigger-based reporting may also enhance energy efficiency at the UE by reducing unnecessary transmissions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

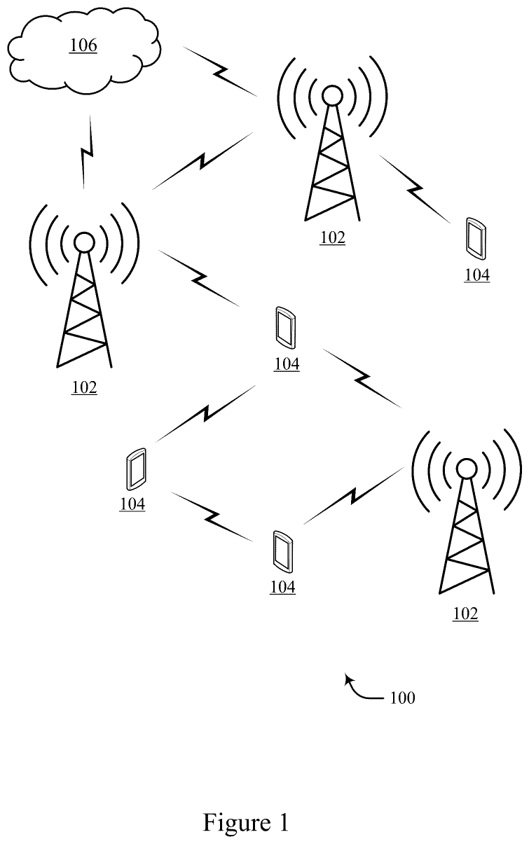

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (N R) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IE EE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the devices in the wireless communications system 100 may implement TDD communications, in which uplink and downlink transmissions between a UE 104 and an NE 102 occur on a same frequency band at different times. For TDD communications, the UE 104 and the NE 102 may alternate between transmitting and receiving within a same frequency band at various times, such as over one or more symbols, slots, or subframes in the time domain. In some examples, the NE 102 may perform channel estimation to manage downlink transmissions to the UE 104. For example, the NE 102 can measure one or more reference signals received from the UE 104 to estimate a channel between the UE 104 and the NE 102. The reference signals can include, but are not limited to, SRSs. There may be channel reciprocity between the uplink channel from the UE 104 to the NE 102 and a downlink channel from the NE 102 to the UE 104, such that the NE 102 can perform measurements on SRSs received via the uplink channel to estimate the downlink channel.

In some cases, the NE 102 can use the SRS measurements to compensate for various channel effects, including multipath fading, shadowing, and interference, among other examples, during beamforming and precoding. The SRS measurements may enable the NE 102 to adapt transmission parameters for a downlink transmission to the UE 104, such as modulation and coding schemes (MCSs), power levels, and beamforming weights, to improve the downlink communication with the UE 104. For example, in a multipath environment, the NE 102 may use SRS measurements to estimate the delay spread and coherence bandwidth of the channel. The NE 102 can select a subcarrier spacing (SCS) and cyclic prefix (CP) length to reduce inter-symbol interference. Additionally, or alternatively, the NE 102 may adjust a transmit power based on a received SRS transmit power to ensure reliable communication with the UE 104. For example, if the received SRS transmit power from a UE 104 is lower than expected, then the NE 102 may increase a transmit power for downlink transmissions to the UE 104. Additionally, or alternatively, the NE 102 may use the SRS measurements from multiple UEs 104 to perform interference estimation and cancellation. Additionally, or alternatively, the NE 102 can use the SRS measurements to estimate one or more spatial characteristics of a channel for spatial multiplexing, where multiple data streams are transmitted simultaneously using different spatial signatures.

In some examples, the UE 104 may transmit SRSs using one or more antenna ports, referred to as SRS ports, providing for the NE 102 to perform channel estimation for multiple spatial layers or beams. An antenna port may refer to a logical mapping of physical antenna elements or physical antennas at a UE 104 to signals for transmission and/or reception. For example, an SRS port is a logical mapping of physical antenna elements or physical antennas at the UE 104 to SRSs for transmission. The UE 104 may have any numerical quantity of SRS ports, each of which may be associated with a different set of physical antenna elements or a different beam direction for transmitting SRSs. The NE 102 may use the SRSs received on different SRS ports to estimate channel characteristics for multiple spatial layers or beam directions, enabling more accurate channel estimation and improved downlink transmission adaptation.

In some cases, a UE 104 may include one or more transmit antennas for transmitting signaling to an NE 102 and/or to other UEs 104, and one or more receive antennas for receiving signaling from an NE 102 and/or from other UEs 104. The UE 104 may use one or more of the receive antennas (e.g., receive only antennas) to transmit defined signaling, such as to transmit the SRSs. The receive antennas that are used for transmitting the SRSs may not have a dedicated PA for adjusting a transmit power from the UE 104 for the SRSs. A PA may amplify (e.g., increase) a power of a signal input to the PA to produce an output signal with a higher power. In some cases, a UE 104 may use a single PA for SRSs from multiple SRS ports. Additionally, or alternatively, the UE 104 may use multiple PAs for SRSs from different groups of SRSs ports. If the UE 104 includes fewer than one PA per SRS port, then the SRS ports at the UE 104 may experience differences in transmit power for SRS transmissions from the SRS ports. For example, the antennas for the SRS ports may be distributed at different physical locations from a PA and/or may be separated from the PA by different components, such that there is a loss between the antennas and the PA. The loss may be referred to as an insertion loss, and may include a trace loss due to the distance the signal travels from the antenna to the PA and/or may include losses from switch components in the circuitry between the antenna and the PA, among other examples.

The SRS transmissions can experience a relatively large difference in transmit power (e.g., greater than a threshold variation in transmit power) across the different antennas due to the insertion losses. The insertion losses can be different for different antennas, leading to incorrect channel estimation and a corresponding decrease in throughput and increase in latency at the UE 104 and the NE 102. To account for the insertion losses, the UE 104 can perform compensation by increasing a transmit power for one or more of the antennas at the PA. The UE 104 can periodically transmit a power headroom report for an SRS port with a lowest insertion loss to an NE 102. For example, the UE 104 can index the SRS ports at the UE 104 based on an insertion loss experienced by the SRS ports, such that an SRS port with a lowest insertion loss across the SRS ports has a lowest index and an SRS port with a highest insertion loss across the SRS ports has a highest index. The power headroom report indicates a remaining transmit power for the SRS port, which is a difference between a maximum transmit power for the SRS port and an actual transmit power for the SRS port. The UE 104 can determine and/or select a maximum transmit power for each SRS port. The NE 102 can compute the transmit power for the remaining SRS ports using the actual transmit power for the SRS port indicated in the power headroom report and fixed insertion loss differences between the SRS ports. However, periodically transmitting the power headroom report may lead to increased signaling overhead and inefficient use of communication resources, as the NE 102 may be able to compute the insertion losses using a single power headroom report until a maximum transmit power for an SRS port is exceeded.

According to implementations, one or more of the NEs 102 and the UEs 104 are operable to implement various aspects of the techniques described with reference to the present disclosure. For example, an NE 102 can indicate for a UE 104 to transmit the power headroom report if a transmit power of at least one SRS port satisfies a threshold value (e.g., exceeds a configured maximum transmit power for the at least one SRS port). For example, if a transmit power of the SRS port with the lowest insertion loss is greater than a difference between the maximum transmit power of the SRS port and a maximum transmit power difference between the maximum transmit powers of the SRS ports, then the UE 104 can transmit a power headroom report for the SRS port with the lowest insertion loss. The maximum transmit power difference may be a difference in a maximum transmit power between the SRS port with the lowest insertion loss and an SRS port with a greatest insertion loss of the SRS ports at the UE 104 and may also represent a difference in insertion loss between the SRS port with the lowest insertion loss and the SRS port with the greatest insertion loss. In some cases, the UE 104 can transmit signaling to the NE prior to transmitting the power headroom report that indicates respective differences between the insertion losses (e.g., maximum transmit powers) for different SRS ports and/or differences between the insertion losses of respective SRS ports relative to the SRS port with the lowest insertion loss. The UE 104 can transmit the SRSs using the SRS ports, and the NE 102 can estimate the channel using the SRSs and the power headroom report to determine transmit powers for the SRS ports of the UE 104.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

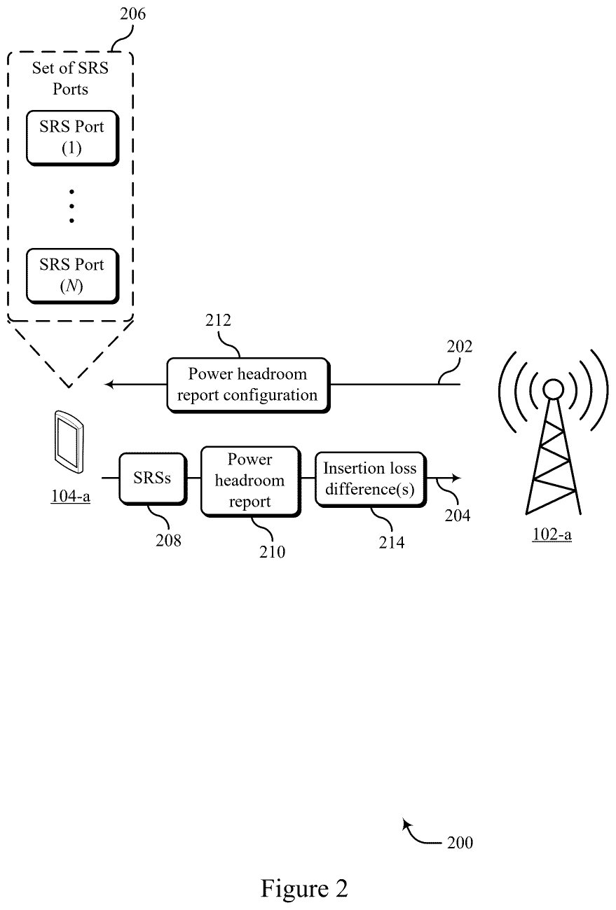

FIG. 2 illustrates an example of a wireless communications system 200 in accordance with aspects of the present disclosure. In some examples, the wireless communications system 200 implements or is implemented by aspects of the wireless communications system 100. For example, the wireless communications system 200 may include an NE 102-a and a UE 104-a, which may be an example of an NE 102 and a UE 104 as described with reference to FIG. 1. The NE 102-a may establish a downlink wireless communications link 202 for transmitting signaling (e.g., data and/or control signaling) to the UE 104-a. Additionally, or alternatively, the UE 104-a may establish an uplink wireless communications link for transmitting signaling (e.g., data and/or control signaling) to the NE 102-a. Although the wireless communications system 200 is illustrated as including a single NE and a single UE, the wireless communications system 200 may include any numerical quantity (e.g., number, amount) of NEs and/or UEs.

In some examples, a UE 104-a may implement a set of SRS ports 206. The set of SRS ports can include any numerical quantity of SRS ports, including an SRS port 1 through an SRS port N, where Nis any integer value. The UE 104-a may index the SRS ports based on an insertion loss difference between the SRS ports and/or relative to a reference SRS port. The reference SRS port (e.g., the SRS port 1) may be an SRS port with a lowest (e.g., least, smallest) insertion loss of the set of SRS ports 206. For example, the UE 104-a may compare each SRS port to the reference SRS port to determine a difference in insertion loss between the SRS port and the reference SRS port. In some other examples, the UE 104-a may compare consecutive SRS ports to determine a difference in insertion loss between the consecutive SRS ports in the set of SRS ports 206. In some cases, an SRS port can be an example of an antenna port allocated for transmitting SRSs 208, which may include transmission from a receive antenna and/or a transmit antenna. The antennas corresponding to the set of SRS ports 206 may have different insertion losses due to being at different physical locations and/or having different configurations relative to a PA.

The different insertion losses can cause a difference in transmit powers for the SRS ports in the set of SRS ports 206 if the UE 104-a does not adjust the transmit powers of the SRS ports to account for the different insertion losses, which may cause incorrect channel estimation at the NE 102-a. For example, the NE 102-a may receive the SRSs 208 from the SRS ports, and if the UE 104-a does not adjust the transmit powers to account for the different insertion losses, then the NE 102-a may not account for the non-reciprocal properties between the uplink channel and the downlink channel introduced by the insertion losses. That is, the receive antennas at the NE 102-a may not experience a same insertion loss as the transmit antennas at the UE 104-a, introducing a non-reciprocal transmit power between the uplink channel and the downlink channel. Further, the insertion loss may depend on a type of a device transmitting the SRSs 208 (e.g., the UE 104-a) due to differences in antenna configurations, including a numerical quantity of transmit antennas and receive antennas, as well as a frequency range used for transmission of the SRSs 208. The insertion loss may be directly proportional to the frequency range, such that higher frequency ranges lead to increased insertion losses. The NE 102-a may select incorrect precoding parameters for the downlink channel (e.g., for a transmission to the UE 104-a), among other examples, as a result of the incorrect channel estimation.

In some examples, the UE 104-a may account for (e.g., compensate for) the insertion loss by updating one or more settings of a PA for each SRS port in the set of SRS ports 206 to increase a transmit power by a value proportional to the insertion loss amount. For example, if there is a 7.5 decibel (dB) loss caused by the insertion loss for an SRS port, then the UE 104-a can use the PA to increase the transmit power for the SRS port by 7.5 dB. In some other examples, the UE 104-a may not adjust the transmit power to account for the insertion loss at each SRS port. Instead, the UE 104-a may indicate the insertion losses for each SRS port, which may be fixed or defined values (e.g., they may not change), and the NE 102-a can use the insertion losses to correct a channel estimation for SRSs received from the SRS ports.

In some cases, the UE 104-a may configure and/or set a maximum transmit power for each SRS port that the UE 104-a may not exceed. The UE 104-a may set the maximum transmit power based on various factors, including, but not limited to, an antenna configuration at the UE 104-a, a resource block (RB) allocation, and a frequency of a transmission, among other examples. The UE 104-a may compensate for the insertion loss for SRS ports up to a maximum transmit power for each SRS port. If the transmit power (e.g., after compensation) exceeds the maximum transmit power for an SRS port, then the UE 104-a can transmit at the maximum transmit power, which may not account for an entirety of the insertion loss for the SRS port. To indicate the power imbalances resulting from the UE 104-a transmitting at the maximum transmit power for an SRS port, rather than compensating for an entirety of the insertion loss for the SRS port, the UE 104-a can transmit a power headroom report 210 to the NE 102-a that indicates a remaining transmit power available for an SRS port. That is, the power headroom report 210 indicates a maximum transmit power for an SRS port, as well as a difference between the maximum transmit power for the SRS port and an actual transmit power for the SRS port. The NE 102-a can use the power headroom report 210 to calculate the actual transmit power for the SRS port, which the NE 102-a can use to correct channel estimations. The UE 104-a may periodically transmit the power headroom report 210, which may lead to increased signaling overhead and inefficient use of communication resources (e.g., time-frequency resources). For example, the NE 102-a may be able to determine (e.g., compute, calculate, obtain) the actual transmit powers for the SRS ports in the set of SRS ports 206 from a reference port and known transmit power offsets between respective SRS ports in the set of SRS ports 206 as long as the UE 104-a does not exceed maximum transmit powers for the SRS ports in the set of SRS ports 206. Thus, the NE 102-a may define a trigger condition that causes the UE 104-a to transmit the power headroom report 210, rather than periodically transmitting the power headroom report 210.

In the wireless communications system 200, an NE 102-a (e.g., a gNB) transmits a power headroom report configuration 212 to a UE 104-a via a downlink wireless communications link 202. The power headroom report configuration 212 indicates for the UE 104-a to perform trigger-based power headroom reporting for the set of SRS ports 206. For example, the NE 102-a can transmit RRC signaling, among other example signaling, that configures the UE 104-a with one or more trigger conditions for transmitting a power headroom report to the NE 102-a. In some examples, the UE 104 transmits one or more insertion loss differences 214, such as at least one of respective insertion loss between a reference SRS port of a set of SRS ports 206 and each of one or more additional ports in the set of SRS ports 206, or differences in configured maximum transmit power values between the reference SRS port of the set of SRS ports 206 and each of one or more additional ports in the set of SRS ports 206 to the NE 102-a. The reference SRS port can be any of the SRS ports, such as the SRS port with the smallest insertion loss. The UE 104-a may transmit the insertion loss differences 214 in uplink signaling via the uplink communication link 204, such as in uplink control information (UCI). The UE 104-a may transmit the insertion loss differences 214 prior to transmitting the power headroom report 210 and/or prior to receiving the power headroom report configuration 212. In some examples, the UE 104-a may transmit updated insertion loss differences 214 if the UE 104-a updates an SRS port configuration for the set of SRS ports 206. That is, the UE 104-a may not report the insertion loss differences 214 to the NE 102-a every time a power headroom report 210 is reported to the NE 102-a. Rather, the UE 104-a may transmit the insertion loss differences 214 to the NE 102-a in response to a change in the insertion losses, such as change in the SRS port to antenna mappings.

The UE 104-a may transmit a power headroom report 210 to the NE 102-a in response to detecting the trigger condition. For example, the UE 104-a may transmit dedicated signaling including the power headroom report 210 and/or may transmit the power headroom report 210 in existing and/or other signaling. The power headroom report 210 indicates how much transmission power is left for the UE 104 to use in addition to the amount of transmission power already being used for an SRS port. The UE 104-a transmits the power headroom report 210 for one SRS port of the UE 104-a (e.g., the SRS port with the smallest insertion loss). The power headroom report is for less than all SRS ports in the set of SRS ports 206 (e.g., for a single SRS port of the set of SRS ports 206).

With respect to the impact of SRS power relaxations on power control behavior, the UE 104-a may define (e.g., set, configure) a configured maximum transmit power, P_{CMAX,f,c}, which may also be referred to as a maximum transmit power, in a range P_{CMAX_L,f,c}≤P_{CMAX,f,c}≤P_{CMAX_H,f,c}. In some cases, the UE 104-a can determine a lower bound of the configured maximum transmit power, P_{CMAX_L,f,c}, according to Equation 1:

P_{CMAX_L,f,c}=MIN{P_{EMAX,c}−ΔT_{C,c},(P_{PowerClass}−ΔP_{PowerClass}+ΔP_{PowerBoost})−MAX(MAX(MPR_{c}+ΔMPR_{c},A−MPR_{c})+ΔT_{IB,c}+ΔT_{C,c}+ΔT_{RxSRS},P−MPR_{c})}. (1)

Additionally, or alternatively, the UE 104-a can determine an upper bound of the configured maximum transmit power, P_{CMAX_H,f,c}, according to Equation 2:

P_{CMAX_H,f,c}=MIN{P_{EMAX,c},P_{PowerClass}−ΔP_{PowerClass}+ΔP_{PowerBoost}}. (2)

Because different SRS ports can have different values of ΔT_{RxSRS}, the UE 104-a can set a configured maximum transmit power for each SRS port. Further, since the configured maximum transmit power P_{CMAX,f,c} may not be equal to P_{CMAX_L,f,c}, the configured maximum transmit power P_{CMAX,f,c} and P_{CMAX,f,c} can be different for two SRS ports even if they have a same value of ΔT_{RxSRS}.

One or more power relaxations can be divided into two types, including a Type 1: MPR_{c}, ΔMPR_{c}, A-MPR_{c}, P-MPR_{c}, ΔP_{PowerClass}, ΔP_{PowerBoost}; and a Type 2: ΔT_{IB,c}, ΔT_{C,c}, ΔT_{RxSRS}. The UE 104-a may take Type 1 maximum transmit power relaxations to meet emissions, regulatory, or other criterion (e.g., requirements). The UE 104-a may determine both the values of the relaxations and the conditions under which the UE 104-a takes the relaxations. The UE 104-a may take power relaxations less than a maximum transmit power relaxation, and the UE 104-a may know the values. The UE 104-a may not apply Type 2 power relaxations. The Type 2 transmit power relaxations are a result of implementation losses. The Type 2 power relaxations exist at all output power levels unless compensated by the UE 104-a. The value of ΔT_{C,c} is 1.5 dB at the band edge and is otherwise 0. The value of ΔT_{IB,c} may be less than 0.5 dB and can be as large as 1.5 dB. A relaxation ΔT_{C,c} is frequency dependent, while the relaxation ΔT_{IB,c} is band combination dependent. A value of the relaxations is not port dependent, but actual values could possibly be port dependent depending on the architecture and the filters used. The allowed relaxation ΔT_{RxSRS} is port dependent and can be denoted as, ΔT_{RxSRS,j}, for the j-th SRS port.

There are three types of power relaxations for implementation losses, including ΔT_{C,c}, ΔT_{IB,c}, and ΔT_{RxSRS,j}. The UE 104-a may compensate for the three types of power relaxations below P_{CMAX}. Additionally, or alternatively, the UE 104-a may compensate for ΔT_{RxSRS,j}, and not the other types of power relaxations. If a UE 104-a indicates that the UE 104-a compensates the SRS power relaxations ΔT_{RxSRS,j} below P_{CMAX}, then the UE 104-a may compensate for the Type 2 power relaxations ΔT_{C,c}, ΔT_{IB,c}, and ΔT_{RxSRS,j}.

With respect to signaling and compensation of SRS power relaxation,

$$Δ {T}_{R xSRS , j}^{A}$$

denotes an actual insertion loss for the j-th antenna port. For two antenna ports i and j, the difference in the configured maximum transmit power between two antenna ports is defined as δ_{i,j}, according to Equation 3:

δ_{i,j}=P_{CMAX,f,c}(i)−P_{CMAX,f,c}(j), (3)

where P_{CMAX_L,f,c}(i) denotes a P_{CMAX} value for the i-th antenna port. In some cases, a difference in the maximum transmit powers for the i-th antenna port and the j-th antenna port, P_{CMAX,f,c}(i)−P_{CMAX,f,c}(j), is equal to a difference between the actual insertion losses for the respective antenna ports,

$$Δ {T}_{R xSRS , j}^{A} - Δ {T}_{R x S R S , i}^{A} ,$$

such that δ_{i,j} can be calculated according to Equation 4:

$${δ}_{i , j} = Δ {T}_{RxSRS , j}^{A} - Δ {T}_{RxSRS , i}^{A} . \qquad ( 4 )$$

For example, a UE 104-a may select a different maximum power reduction (MPR) or additional-MPR (A-MPR) relaxation (e.g., less than a maximum allowed) for an i-th antenna port than for a j-th antenna port.

In some examples, a difference between a configured maximum transmit power for two ports i and j is given by Equation 3. The difference between the configured maximum transmit power is fixed and is independent of the RB allocation. Further, the difference between the configured maximum transmit power is equal to a difference in insertion loss for SRSs 208 (e.g., SRS insertion loss), as shown in Equation 4. The N antenna ports used for an SRS transmission are numbered (e.g., indexed), such that δ_{1,j}≥0 for all 1≤j≤N. For example, port 1 could be defined for an SRS port with no relaxation, such that

$$Δ {T}_{RxSRS , 1}^{A} = 0.$$

If the UE 104-a uses port 1, then P_{CMAX,f,c}(1)−P_{CMAX,f,c}(j)≥0 for 1≤j≤N. Equivalently, P_{CMAX,f,c}(1)≥P_{CMAX,f,c}(j) for all 1≤j≤N.

For each SRS occasion, the UE 104-a may signal a power headroom report 210 for port 1. The power headroom report 210 may include a power headroom. A power headroom is a difference between a configured maximum transmit power and an actual transmit power. That is, the power headroom report for port 1 may include the power headroom given by Equation 5:

p_{H,1}=P_{CMAX,f,c}(1)−p_{t,1}, (5)

where P_{CMAX,f,c}(1) is the configured maximum transmit power for port 1 (e.g., for a given RB allocation) and p_{t,1} is a transmit power on port 1. The power headroom report 210 may optionally include a configured maximum transmit power, in which case the transmitted power can be determined according to Equation 6:

p_{t,1}=P_{CMAX,f,c}(1)−p_{H,1}. (6)

The UE 104-a can manage insertion losses according to various methods. For example, the UE 104-a can compensate the transmit power for the insertion loss

$$Δ {T}_{RxSRS , i}^{A}$$

for each antenna port i up to P_{CMAX,f,c}(i). Additionally, or alternatively, the UE 104-a does not compensate the transmit power for the insertion losses. If the UE 104-a compensates for the insertion loss for each antenna port, then the insertion loss that is compensated is an actual SRS insertion loss

$$Δ {T}_{RxSRS , j}^{A}$$

or the compensated insertion loss is a sum of the actual SRS insertion loss

$$Δ {T}_{RxSRS , j}^{A}$$

and the other insertion losses ΔT_{C,c} and ΔT_{IB,c}. Unless ΔT_{C,c} and ΔT_{IB,c} are port dependent, then P_{CMAX,f,c}(i)−

$${P}_{CMAX , f , c} ( j ) = Δ {T}_{RxSRS , j}^{A} - Δ {T}_{RxSRS , i}^{A} = {δ}_{i , j} .$$

For both methods of managing insertion loss, the transmit power for any port j can be determined from the difference in the insertion loss, δ_{1,j}, the power headroom for a first antenna port, p_{H,1}, and a configured maximum transmit power for the first antenna port, P_{CMAX,f,c}(1), from which p_{t,1} can be computed according to Equation 7:

p_{t,1}=P_{CMAX,f,c}(1)−p_{H,1}. (7)

If the UE 104-a compensates for the insertion loss for each antenna port, then the UE 104-a compensates the insertion loss for the j-th antenna port up to P_{CMAX,f,c}(j) for the j-th antenna port which can be expressed according to Equation 8:

P_{CMAX,f,c}(j)=P_{CMAX,f,c}(1)−(P_{CMAX,f,c}(1)−P_{CMAX,f,c}(j))=P_{CMAX,f,c}(1)−δ_{1,j}. (8)

As the UE 104-a compensates the insertion loss, the transmit power for the j-th antenna port is given by Equation 9:

$${p}_{t , j} = \{ \begin{matrix}{p}_{t , 1} & {p}_{t , 1} \leq {P}_{CMAX , f , c} ( 1 ) - {δ}_{1 , j} \\ {P}_{CMAX , f , c} ( 1 ) - {δ}_{1 , j} & {p}_{t , 1} > {P}_{CMAX , f , c} ( 1 ) - {δ}_{1 , j}\end{matrix} . \qquad ( 9 )$$

Thus, the power p_{t,j} for the j-th antenna port can be determined from knowledge of the power p_{t,1} of the first antenna port, the configured maximum transmit power for the first antenna port, and the insertion loss difference δ_{1,j}. In some cases, P_{CMAX,f,c}(1)≥P_{CMAX,f,c}(j) for all 1≤j≤N. Otherwise, there exists an index j, such that P_{CMAX,f,c}(j)>P_{CMAX,f,c}(1). In this case in which the insertion loss for each port i is compensated up to the configured maximum transmit power P_{CMAX,f,c}(i) for the port, for the j-th port, p_{t,j}=p_{t,1} for p_{t,1}≤P_{CMAX,f,c}(1). However, if P_{CMAX,f,c}(1)<p_{t,j}≤P_{CMAX,f,c}(j), then p_{t,j}>p_{t,1}, and in the range, the value of p_{t,j} cannot be determined from the value of p_{t,1}.

If the UE 104-a does not compensate the transmit power for the insertion losses, then p_{t,j}=p_{t,1}−δ_{1,j}, where,

$${δ}_{i , j} = {P}_{CMAX , f , c} ( 1 ) - {P}_{CMAX , f , c} ( j ) = Δ {T}_{RxSRS , j}^{A} - Δ {T}_{RxSRS , i}^{A} .$$

In this second case, since the power difference between the antenna ports is fixed, the NE 102-a can determine the power for any port j, p_{t,j}, from the power of any other port i, p_{t,i}, if the NE 102-a determines (e.g., knows, obtains) a power difference between the two ports, which is calculated according to Equation 4.

The NE 102-a can use one or more techniques to correct the SRS based channel estimates for the power imbalances. To estimate the channel between an SRS port at the UE 104-a and a receiver (e.g., receive antenna) at the NE 102-a, the UE 104-a transmits reference symbols from the SRS port (e.g., the SRSs 208). In some cases, x₁ and xⱼ denote unit amplitude reference symbols transmitted from port 1 and port j, respectively, and y₁ and yⱼ denote the corresponding received symbols at the NE 102-a given by Equation 10:

y₁=h₁x₁\sqrt{p_{t,1}}+n₁yⱼ=hⱼxⱼ\sqrt{p_{t,j}}+nⱼ. (10)

Here, h₁ and hⱼ denote the channels from the first antenna port and the j-th antenna port to the NE 102-a, p_{t,1} and p_{t,j} denote the power transmitted on the two ports, and n₁ and nⱼ are additive noise terms. With knowledge of the transmit powers p_{t,1} and p_{t,j}, the channels h₁ and hⱼ can be estimated according to Equation 11:

$${\hat{h}}_{1} = {y}_{1} \frac{{x}_{1}^{*}}{\sqrt{{p}_{t , 1}}} and {\hat{h}}_{j} = {y}_{j} \frac{{x}_{1}^{*}}{\sqrt{{p}_{t , j}}} . \qquad ( 11 )$$

If the power transmitted from the j-th port is less than the power transmitted from the first port by δ_{1,j} dB, then the channel estimate ĥⱼ can be computed according to Equation 12:

$${\hat{h}}_{j} = {y}_{j} \frac{{x}_{1}^{*}}{\sqrt{{p}_{t , j}}} {10}^{{δ}_{1 , j} / 20} . \qquad ( 12 )$$

In the case that the power headroom report 210 includes both the power headroom and the configured maximum transmit power, the power p_{t,1} transmitted on the first antenna port may be determined at the NE 102-a from the power headroom report according to Equation 6. Additionally, or alternatively, the NE 102-a may determine p_{t,1} from a previous power headroom report that includes both the configured maximum transmit power and a sum of the power control commands transmitted in the time interval between the previous power headroom report and the time at which the reference symbol is received from the first antenna port.

In some examples, the UE 104-a signals the set of values δ_{1,j} for all 1≤j≤N to the NE 102-a (e.g., a gNB) in the insertion loss differences 214 signaling, where N is the number of SRS ports. The UE 104-a obtains the values for δ_{1,j}, according to Equation 3. In some cases, the SRS ports are numbered (e.g., indexed) such that δ_{1,j}≥0 for all 1≤j≤N. The values are a function of the switching and trace losses. The UE 104-a may signal these values when there is a change in the mapping or numbering of the antenna ports (e.g., the SRS ports in the set of SRS ports 206).

Subsequent to the insertion loss differences 214, the UE 104 indicates whether or not the UE 104-a compensates the SRS transmit power for the i-th antenna port up to the configured maximum transmit power for the port given by P_{CMAX,f,c}(i). In some examples, for each SRS occasion, the UE 104 signals a power headroom report 210 for port 1. The power headroom report 210 provides the power headroom, as defined by Equation 5, where P_{CMAX,f,c}(1) is the configured maximum transmit power for port 1 (e.g., for the given RB allocation) and p_{t,1} is the transmitted power on port 1. Additionally, or alternatively, the power headroom report 210 includes the configured maximum transmit power, so that the transmitted power can be determined according to Equation 6. For a UE 104-a that compensates the SRS insertion loss for the j-th antenna port up to P_{CMAX,f,c}(1), the NE 102-a corrects the channel estimate for p_{t,j} using δ_{1,j}, p_{t,1}, and P_{CMAX,f,c}(1) using Equation 9. For a UE 104-a that does not compensate the SRS insertion loss, the NE 102-a corrects the channel estimate for the j-th UE antenna port from δ_{1,j} and p_{t,1} using p_{t,j}=p_{t,1}−δ_{1,j}.

The NE 102-a may define a trigger condition for transmitting the power headroom report 210. For example, the NE 102-a uses the power transmitted by the UE 104-a on each of the SRS ports to correctly estimate the channel. If the antenna ports do not compensate for the actual SRS related insertion loss, then there will be a fixed (e.g., defined, unchanging) offset of transmit power between the antenna ports regardless of the power level of the first transmit port. Specifically, the power offset between the i-th antenna port and the j-th antenna port is given by

$${δ}_{i , j} = Δ {T}_{RxSRS , i}^{A} - Δ {T}_{RxSRS , j}^{A} .$$

That is, in all cases, Equation 13 is satisfied:

p_{t,j}=p_{t,1}−δ_{1,j}. (13)

Thus, if the UE 104-a does not compensate the SRS insertion losses, then the NE 102-a can determine the power differences between the antenna ports without type 3 power headroom reports for the SRS ports. The NE 102-a may determine p_{t,1} from a previous power headroom report that includes both the configured maximum transmit power and the sum of the power control commands transmitted in the time interval between the previous power headroom report and the time at which the reference symbol is received from the first antenna port.

Additionally, or alternatively, if the UE 104-a compensates for the SRS insertion losses, then p_{t,j}=p_{t,1} for p_{t,1}≤P_{CMAX,f,c}(j). If p_{t,1}>P_{CMAX,f,c}(j), then the NE 102-a can use Equation 9 to obtain the transmit power for the j-th antenna port. However, the NE 102-a may use P_{CMAX,f,c}(1) to compute the term P_{CMAX,f,c}(1)−δ_{1,j}. Thus, if p_{t,1}>P_{CMAX,f,c}(j), the NE 102-a can determine p_{t,j} if the UE 104-a signals a power headroom report 210 (e.g., type 3) for port 1 that includes both the power headroom for port 1 and the configured maximum transmit power for port 1. Since the NE 102-a may compute p_{t,j} for any port j, the UE 104-a may transmit a type 3 power headroom report for port 1 with both the power headroom for port 1 and P_{CMAX,f,c}(1) for any SRS allocation for which

$${p}_{t , 1} > {P}_{CMAX , f , c} ( 1 ) - {max}_{j} {δ}_{1 , j} .$$

Thus, if the UE compensates for the SRS insertion losses, then the NE 102-a may determine p_{t,j} for all ports j using Equation 9, as long as the UE transmits a type 3 power headroom report for port 1 with both the power headroom for port 1 and P_{CMAX,f,c}(1) for any SRS allocation for which

$${p}_{t , 1} > {P}_{CMAX , f , c} ( 1 ) - {max}_{j} {δ}_{1 , j} .$$

The UE 104-a may transmit the power headroom report 210 (e.g., the type 3 power headroom report) for port 1, where port 1 is defined as the SRS port with a lowest (e.g., smallest, least) actual SRS insertion loss

$$Δ {T}_{RxSRS , i}^{A} .$$

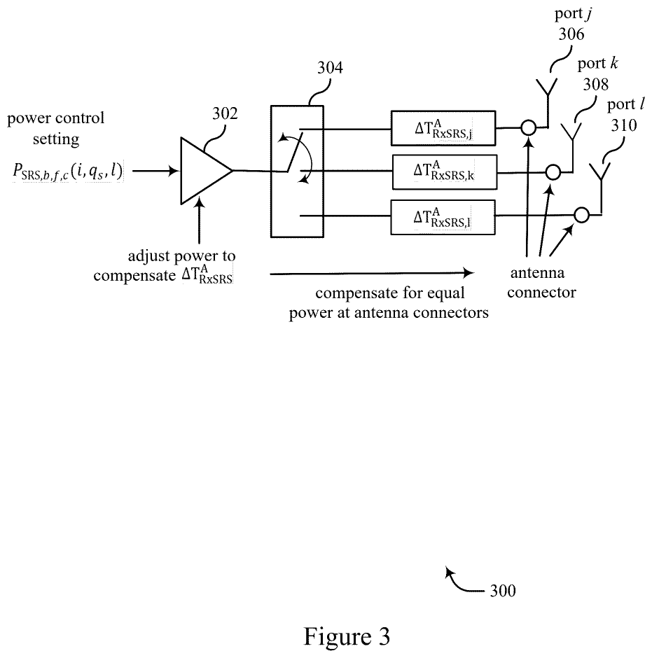

FIG. 3 illustrates an example of a transmission architecture 300 in accordance with aspects of the present disclosure. In some examples, the transmission architecture 300 implements or is implemented by aspects of the wireless communications system 100 and the wireless communications system 200. For example, the transmission architecture 300 may be implemented by a UE, which may be an example of a UE 104 as described with reference to FIGS. 1 and 2.

The transmission architecture 300 illustrates compensation of

$$Δ {T}_{RxSRS}^{A}$$

implementation losses. The transmission architecture 300 includes the output power versus the power control setting P_{SRS,b,f,c}(i, qₛ, l, p) in combination with the actual power relaxations

$$Δ {T}_{R x S R S}^{A} .$$

A UE actively compensates for losses by adjusting the power at a PA 302 when activating a switch 304 between the SRS ports (e.g., port j 306, port k 308, and port l 310), as shown in the transmission architecture 300. The PA 302 may be at a physical location closest to antennas that are used on a regular basis for both transmitting and receiving, and farther away from antennas that primarily receive signaling except for transmitting SRSs. This physical arrangement results in different insertion losses for different antenna ports, with the antennas primarily used for receiving signaling experiencing greater insertion losses due to longer trace distances on the circuit board and additional switching components (e.g., the switch 304) in the signal path.

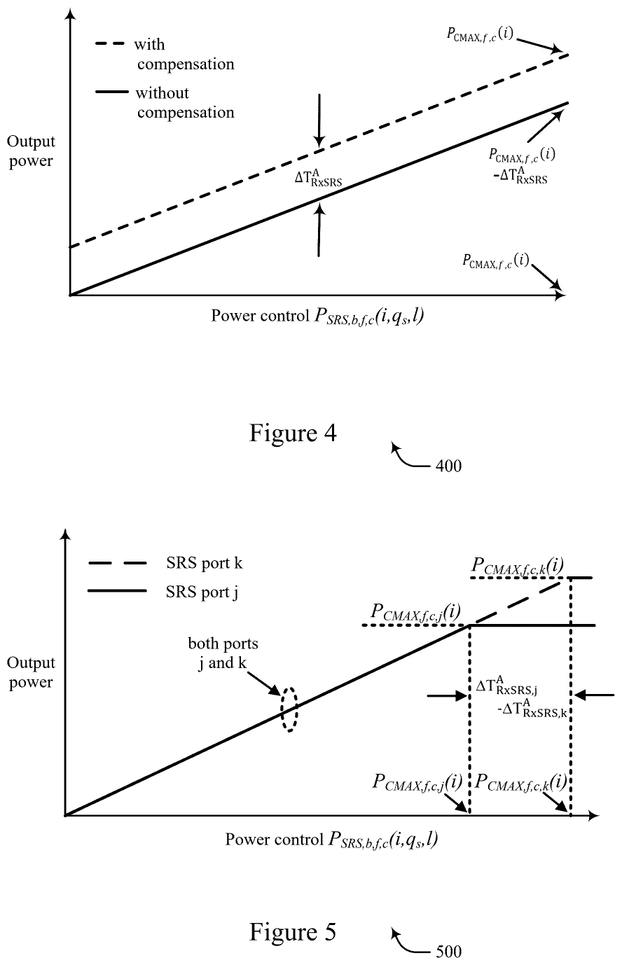

FIG. 4 illustrates an example of a power diagram 400 in accordance with aspects of the present disclosure. In some examples, the power diagram 400 implements or is implemented by aspects of the wireless communications system 100, the wireless communications system 200, and the transmission architecture 300. For example, the power diagram 400 may be implemented by a UE, which may be an example of a UE 104 as described with reference to FIGS. 1 and 2. The power diagram 400 illustrates SRS output power versus power control with and without compensation of

$$Δ {T}_{R x S R S}^{A} .$$

In the power diagram 400, the SRS output power is shown as a function of the power control setting P_{SRS,b,f,c}(i, qₛ,l, p) both when the implementation loss,

$$Δ {T}_{RxSRS}^{A} ,$$

is compensated and when the implementation loss is not compensated. From the power diagram 400, if the implementation loss is not compensated, then the SRS output power is shifted down by

$$Δ {T}_{RxSRS}^{A} .$$

Further, the configured maximum transmit power at the antenna connector is reduced to

$${P}_{C M A X , f , c , p} ( i ) - Δ {T}_{R x S R S}^{A} .$$

Unless the UE compensates the SRS relaxations as indicated in FIG. 3, the SRS output power will lag the power control setting P_{SRS,b,f,c}(i, qₛ,l, p) by

$$Δ {T}_{R x S R S , p}^{A} .$$

Since the maximum value of the power control setting P_{SRS,b,f,c}(i, qₛ, l, p) is P_{CMAX,f,c,p}(i), the configured maximum transmit power at the antenna connector will be

$${P}_{C M A X , f , c , p} ( i ) - Δ {T}_{R x S R S , p}^{A} . Since {P}_{CMAX , f , c , p} ( i )$$

was already reduced by

$$Δ {T}_{R x S R S , p}^{A}$$

(e.g., assuming the configured maximum transmit power is equal to its lower bound) the reduction of P_{CMAX,f,c,p}(i) by

$$Δ {T}_{R x S R S , p}^{A}$$

without compensation by the PA has the effect of reducing the configured maximum transmit power by

$$2 \cdot Δ {T}_{R x S R S}^{A} .$$

Unless the SRS implementation loss

$$Δ {T}_{R x S R S , p}^{A}$$

is compensated by the UE, the total reduction in configured maximum transmit power will be

$$2 \cdot Δ {T}_{R x S R S}^{A} .$$

The implementation losses can be relatively large (e.g., greater than a threshold value, as large as 7.5 dB), particularly in higher frequency ranges where trace losses increase. Without proper compensation, the implementations losses can cause errors in downlink channel estimation, leading to incorrect precoder selection by an NE, as described with reference to FIGS. 1 and 2.

FIG. 5 illustrates an example of a power diagram 500 in accordance with aspects of the present disclosure. In some examples, the power diagram 500 implements or is implemented by aspects of the wireless communications system 100, the wireless communications system 200, the transmission architecture 300, and the power diagram 500. For example, the power diagram 500 may be implemented by a UE, which may be an example of a UE 104 as described with reference to FIGS. 1 and 2. The power diagram 500 illustrates power difference between SRS ports versus power control with compensation of

$$Δ {T}_{R x S R S}^{A} .$$

In the power diagram 500, the SRS output power is shown for SRS ports j and kas a function of the power control setting P_{SRS,b,f,c}(i, qₛ, l, p) for the case that the UE compensates the SRS power relaxations. In the power diagram 500, P_{CMAX,f,c,j}(i) and P_{CMAX,f,c,k}(i) denote the configured maximum transmit power for SRS ports j and k, respectively, and

$$Δ {T}_{RxSRS , j}^{A} and Δ {T}_{RxSRS , k}^{A}$$

denote the actual SRS power relaxations. From the power diagram 500, there may be no difference in the output power for the two SRS ports unless the power control setting is greater than P_{CMAX,f,c,j}(i). In this region, the output power for the k-th SRS port exceeds the power for the j-th port by the difference P_{SRS,b,f,c}(i, qₛ, l)−P_{CMAX,f,c,j}(i). In some cases, the difference in configured maximum transmit powers for the two SRS ports is given by

$$Δ {T}_{R xSRS , j}^{A} - Δ {T}_{R x S R S , k}^{A} .$$

The power diagram 500 illustrates an example of a UE compensating for insertion losses, where the power output is equal across all SRS ports until an SRS port reaches a configured maximum transmit power. At that point, the transmit power for an SRS port with the higher insertion loss will flatten out (e.g., saturate), while other ports with lower insertion losses can continue to increase a transmit power. The transmit power flattening out at the configured maximum transmit power creates a power imbalance between SRS ports, which can be accounted for at the NE for channel estimation, as described with reference to FIG. 2.

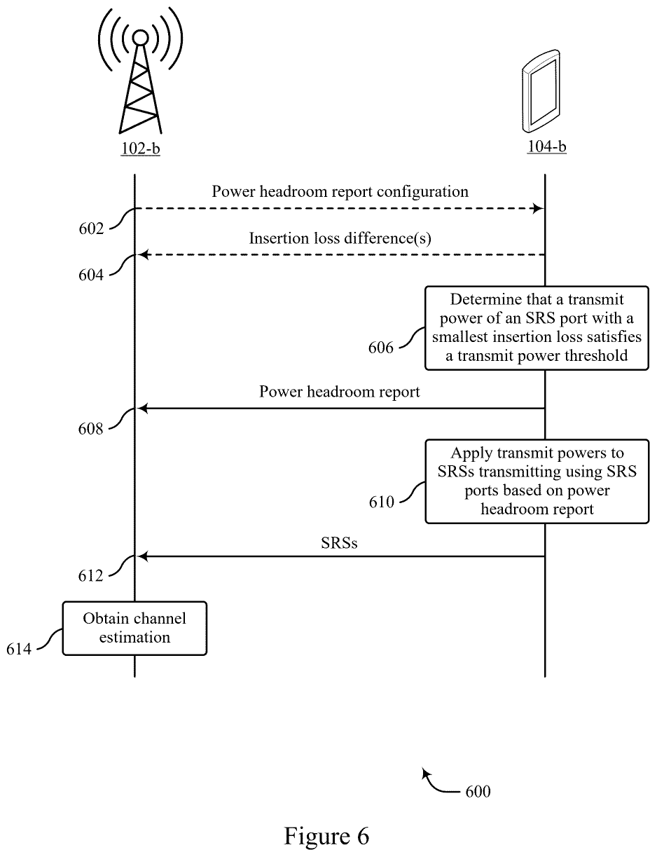

FIG. 6 illustrates an example signaling diagram 600 in accordance with aspects of the present disclosure. In some examples, the signaling diagram 600 implements or is implemented by aspects of the wireless communications system 100, the wireless communications system 200, the transmission architecture 300, the power diagram 400, and the power diagram 500. The signaling diagram 600 may implement or be implemented by an NE 102-b and a UE 104-b, which may be examples of the corresponding devices as described with reference to FIGS. 1 through 5. For example, the NE 102-b may configure the UE 104-b to perform trigger-based power headroom reporting. Alternative examples of the following may be implemented, where some processes are performed in a different order than described or are not performed. In some cases, processes may include additional features not mentioned below, or further processes may be added.

At 602, the NE 102-b transmits a power headroom report configuration to the UE 104-b. The configuration indicates for the UE 104-b to perform trigger-based power headroom reporting for a set of SRS ports. The configuration allocates one or more time-frequency resources for the power headroom report and specifies a transmit power threshold for triggering the report. The NE 102-b may transmit the configuration via RRC signaling or other control signaling.

At 604, the UE 104-b transmits insertion loss differences to the NE 102-b. The signaling indicates at least one of first respective differences in insertion loss between the set of SRS ports or second respective differences in insertion losses corresponding to the set of SRS ports relative to an SRS port with the smallest insertion loss. The insertion loss differences may be transmitted in UCI or other uplink signaling. The UE 104-b may index the SRS ports based on insertion loss, with the port having the smallest insertion loss assigned the lowest index (e.g., port 1). The insertion loss differences may be defined or fixed values that the UE 104-b reports upon detection of a change in the SRS port configuration, such as when the UE 104-b updates one or more antenna port mappings. The insertion loss differences can be represented as a delta value (e.g., δ_{i,j}) that indicate the difference in insertion loss between the reference SRS port (e.g., port 1) and each other SRS port and/or between consecutive SRS ports.

At 606, the UE 104-b determines that a transmit power associated with the SRS port having the smallest (e.g., lowest, least) insertion loss satisfies the transmit power threshold specified in the configuration. The transmit power threshold is based on a maximum transmit power associated with the SRS port (e.g., having the smallest insertion loss). Specifically, the trigger condition occurs when the transmit power for the SRS port with the smallest insertion loss exceeds a threshold defined as the configured maximum transmit power for that port minus the maximum insertion loss difference among all ports. The threshold represents the point at which at least one SRS port reaches a configured maximum transmit power and can no longer fully compensate for an insertion loss, creating a power imbalance between ports. The UE 104-b can notify the NE 102-b of the power imbalance via a power headroom report.

For example, at 608, in response to the transmit power threshold being satisfied, the UE 104-b transmits a power headroom report to the NE 102-b. The UE 104-b transmits the power headroom report for the SRS port with the smallest insertion loss, rather than for all SRS ports. The report includes a power headroom associated with this SRS port and additional information including the maximum transmit power associated with the port. The UE 104-b transmits the power headroom report in an uplink control channel as dedicated signaling. The power headroom report may include both the power headroom (e.g., the difference between the configured maximum transmit power and the actual transmit power) and the configured maximum transmit power, as the NE 102-b uses both values to calculate the actual transmit power used by the UE 104-b. The configured maximum transmit power depends on various factors, including resource block allocation, and can change dynamically.

At 610, the UE 104-b applies transmit powers to SRSs for transmission using the set of SRS ports. For SRS ports where the transmit power does not exceed the maximum transmit power for that port, the UE 104-b applies the actual transmit power. For any remaining SRS ports where the transmit power would exceed a maximum transmit power, the UE 104-b applies the maximum transmit power for the SRS ports. That is, when compensating for insertion losses, the UE 104-b increases the PA output for SRS ports with higher insertion losses. However, once the transmit power exceeds the maximum capability of the PA for a particular port, the UE 104-b transmits at the configured maximum transmit power for that SRS port. For example, if the PA is designed for 23 dB output and an SRS port has 7.5 dB of insertion loss, then the UE 104-b compensates for the loss up to a transmit power of 15.5 dB. Beyond this point, the SRS port transmits at a maximum transmit power, while other ports with lower insertion losses can continue to increase a transmit power.

At 612, the UE 104-b transmits one or more SRSs to the NE 102-b using the set of SRS ports, with the applied transmit powers determined at 610. The UE 104-b transmits the SRSs using the set of SRS ports, which may include both transmit antennas and receive antennas that are temporarily used for SRS transmission. The SRSs enable the NE 102-b to perform channel estimation for the downlink channel based on channel reciprocity in TDD systems.

At 614, the NE 102-b obtains an estimation of the channel corresponding to the received SRSs. The channel estimation is based on applying the transmit powers used for the SRS ports, as indicated in the power headroom report and known insertion loss differences. The NE 102-b can calculate the actual transmit power for the reference SRS port (e.g., port 1) using the power headroom and configured maximum transmit power from the power headroom report. For other SRS ports, the NE 102-b can determine transmit powers using the known insertion loss differences and the calculated transmit power of the reference SRS port. For SRS ports that have reached a maximum transmit power, the NE 102-b uses the configured maximum transmit power for the SRS ports. The NE 102-b then applies the power values to correctly scale the channel estimates for each SRS port, ensuring channel estimation that accounts for power imbalances between ports. The NE 102-b uses the channel estimation for downlink precoding and beamforming decisions, among other examples.

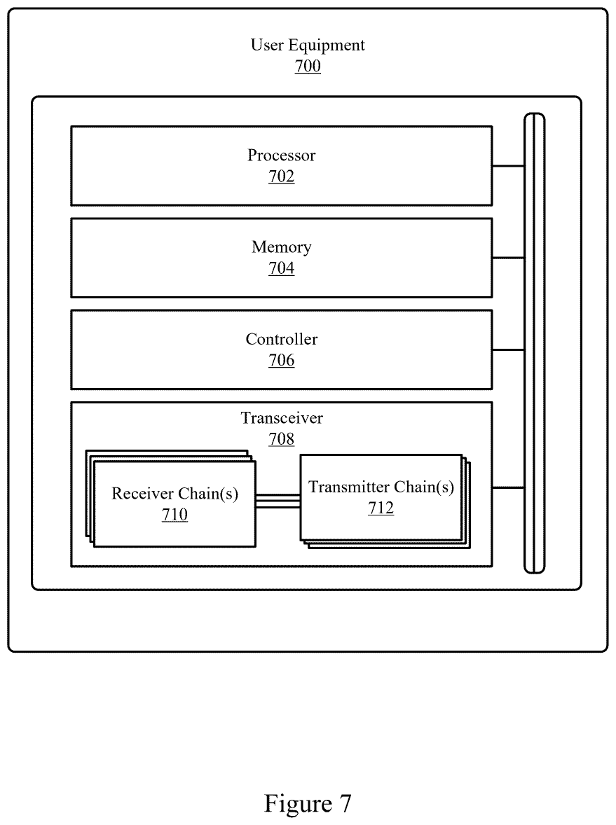

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field-programmable gate-array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for transmitting a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports, and transmitting, based on the power headroom report, one or more SRSs using the set of SRS ports.

Additionally, the UE 700 may be configured to support any one or combination of respective transmit powers associated with the set of SRS ports correspond to respective differences in insertion losses between the SRS port and respective additional SRS ports of the set of SRS ports up to respective maximum transmit powers associated with the set of SRS ports, where the power headroom report includes a power headroom associated with the SRS port. Additionally, or alternatively, the UE 700 may be configured to support the transmit power threshold is based on an additional SRS port of the set of SRS ports, and where the additional SRS port is associated with a largest insertion loss of the respective insertion losses associated with the set of SRS ports. Additionally, or alternatively, the UE 700 may be configured to support transmitting, prior to the power headroom report, signaling that indicates at least one of first respective differences in insertion loss between the set of SRS ports or second respective differences in insertion losses corresponding to the set of SRS ports relative to the SRS port.

Additionally, or alternatively, the UE 700 may be configured to support receiving, prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. Additionally, or alternatively, the UE 700 may be configured to support transmitting signaling including the power headroom report for the SRS port and additional information including the maximum transmit power associated with the SRS port. Additionally, or alternatively, the UE 700 may be configured to support transmitting, in an uplink control channel, dedicated signaling including the power headroom report.

Additionally, or alternatively, the UE 700 may be configured to support applying respective transmit powers associated with one or more SRS ports of the set of SRS ports to the one or more SRSs transmitted using the one or more SRS ports, where the respective transmit powers associated with the one or more SRS ports include values up to respective maximum transmit powers associated with the one or more SRS ports, and applying respective maximum transmit powers associated with one or more remaining SRS ports of the set of SRS ports to the one or more SRSs transmitted using the one or more remaining SRS ports based on respective transmit powers associated with the one or more remaining SRS ports exceeding the respective maximum transmit powers associated with the one or more remaining SRS ports. Additionally, or alternatively, the UE 700 may be configured to support an estimation of a channel corresponding to the one or more SRSs is based on applying at least one of the respective transmit powers associated with the one or more SRS ports or the respective maximum transmit powers associated with the one or more remaining SRS ports.

Additionally, or alternatively, the UE 700 may support at least one memory (e.g., the memory 704) and at least one processor (e.g., the processor 702) coupled with the at least one memory and configured to cause the UE to transmit a power headroom report based on a transmit power associated with a SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports, and transmit, based on the power headroom report, one or more SRSs using the set of SRS ports.

Additionally, the UE 700 may be configured to support any one or combination of respective transmit powers associated with the set of SRS ports correspond to respective differences in insertion losses between the SRS port and respective additional SRS ports of the set of SRS ports up to respective maximum transmit powers associated with the set of SRS ports, where the power headroom report includes a power headroom associated with the SRS port. Additionally, or alternatively, the UE 700 may be configured to support the transmit power threshold is based on an additional SRS port of the set of SRS ports, and where the additional SRS port is associated with a largest insertion loss of the respective insertion losses associated with the set of SRS ports. Additionally, or alternatively, the UE 700 may be configured to support to transmit, prior to the power headroom report, signaling that indicates at least one of first respective differences in insertion loss between the set of SRS ports or second respective differences in insertion losses corresponding to the set of SRS ports relative to the SRS port.

Additionally, or alternatively, the UE 700 may be configured to support to receive, prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. Additionally, or alternatively, the UE 700 may be configured to support to transmit signaling including the power headroom report for the SRS port and additional information including the maximum transmit power associated with the SRS port. Additionally, or alternatively, the UE 700 may be configured to support to transmit, in an uplink control channel, dedicated signaling including the power headroom report.

Additionally, or alternatively, the UE 700 may be configured to support to apply respective transmit powers associated with one or more SRS ports of the set of SRS ports to the one or more SRSs transmitted using the one or more SRS ports, where the respective transmit powers associated with the one or more SRS ports include values up to respective maximum transmit powers associated with the one or more SRS ports, and apply respective maximum transmit powers associated with one or more remaining SRS ports of the set of SRS ports to the one or more SRSs transmitted using the one or more remaining SRS ports based on respective transmit powers associated with the one or more remaining SRS ports exceeding the respective maximum transmit powers associated with the one or more remaining SRS ports. Additionally, or alternatively, the UE 700 may be configured to support an estimation of a channel corresponding to the one or more SRSs is based on applying at least one of the respective transmit powers associated with the one or more SRS ports or the respective maximum transmit powers associated with the one or more remaining SRS ports.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 712 may also include at least one PA configured to amplify the modulated signal to an appropriate power level suitable for transmission over the wireless medium. The transmitter chain 712 may also include one or more antennas for transmitting the amplified signal into the air or wireless medium.

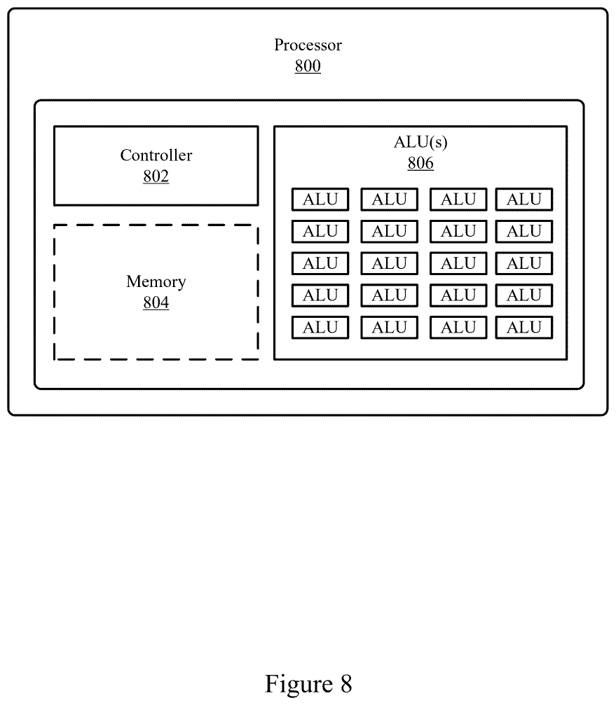

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to transmit a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports, and transmit, based on the power headroom report, one or more SRSs using the set of SRS ports.

Additionally, the processor 800 may be configured to or operable to support any one or combination of respective transmit powers associated with the set of SRS ports correspond to respective differences in insertion losses between the SRS port and respective additional SRS ports of the set of SRS ports up to respective maximum transmit powers associated with the set of SRS ports, where the power headroom report includes a power headroom associated with the SRS port. Additionally, or alternatively, the processor 800 may be configured to or operable to support any one or combination of the transmit power threshold is based on an additional SRS port of the set of SRS ports, and where the additional SRS port is associated with a largest insertion loss of the respective insertion losses associated with the set of SRS ports. Additionally, or alternatively, the processor 800 may be configured to or operable to support any one or combination of to transmit, prior to the power headroom report, signaling that indicates at least one of first respective differences in insertion loss between the set of SRS ports or second respective differences in insertion losses corresponding to the set of SRS ports relative to the SRS port.

Additionally, or alternatively, the processor 800 may be configured to or operable to support any one or combination of to receive, prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. Additionally, or alternatively, to transmit the power headroom report, the processor 800 may be configured to or operable to support any one or combination of to transmit signaling including the power headroom report for the SRS port and additional information including the maximum transmit power associated with the SRS port. Additionally, or alternatively, to transmit the power headroom report, the processor 800 may be configured to or operable to support any one or combination of to transmit, in an uplink control channel, dedicated signaling including the power headroom report.

Additionally, or alternatively, to transmit the one or more SRSs, the processor 800 may be configured to or operable to support any one or combination of to apply respective transmit powers associated with one or more SRS ports of the set of SRS ports to the one or more SRSs transmitted using the one or more SRS ports, where the respective transmit powers associated with the one or more SRS ports include values up to respective maximum transmit powers associated with the one or more SRS ports, and apply respective maximum transmit powers associated with one or more remaining SRS ports of the set of SRS ports to the one or more SRSs transmitted using the one or more remaining SRS ports based on respective transmit powers associated with the one or more remaining SRS ports exceeding the respective maximum transmit powers associated with the one or more remaining SRS ports. Additionally, the processor 800 may be configured to or operable to support any one or combination of an estimation of a channel corresponding to the one or more SRSs is based on applying at least one of the respective transmit powers associated with the one or more SRS ports or the respective maximum transmit powers associated with the one or more remaining SRS ports.

The processor 800 may be configured to or operable to support at least one controller (e.g., the controller 802) coupled with at least one memory (e.g., the memory 804) and configured to cause the processor to receive a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports, and receive, based on the power headroom report, one or more SRSs corresponding to the set of SRS ports.

Additionally, the processor 800 may be configured to or operable to support anyone or combination of respective transmit powers associated with the set of SRS ports correspond to respective differences in insertion losses between the SRS port and respective additional SRS ports of the set of SRS ports up to respective maximum transmit powers associated with the set of SRS ports. Additionally, or alternatively, the processor 800 may be configured to or operable to support any one or combination of the power headroom report includes a power headroom associated with the SRS port, where the transmit power threshold is based on an additional SRS port of the set of SRS ports, and where the additional SRS port is associated with a largest insertion loss of the respective insertion losses associated with the set of SRS ports. Additionally, or alternatively, the processor 800 may be configured to or operable to support any one or combination of to receive, prior to the power headroom report, signaling that indicates at least one of first respective differences in insertion loss between the set of SRS ports or second respective differences in insertion losses corresponding to the set of SRS ports relative to the SRS port.

Additionally, or alternatively, the processor 800 may be configured to or operable to support any one or combination of to transmit, to a UE and prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. Additionally, or alternatively, to receive the power headroom report the processor 800 may be configured to or operable to support any one or combination of to receive signaling including the power headroom report for the SRS port and additional information including the maximum transmit power associated with the SRS port. Additionally, or alternatively, to receive the power headroom report the processor 800 may be configured to or operable to support any one or combination of to receive, in an uplink control channel, dedicated signaling including the power headroom report.

Additionally, or alternatively, to receive the one or more SRSs the processor 800 may be configured to or operable to support any one or combination of to determine, based on the power headroom report, respective transmit powers associated with one or more SRS ports of the set of SRS ports applied to the one or more SRSs transmitted using the one or more SRS ports of the set of SRS ports, where the respective transmit powers associated with the one or more SRS ports include values up to respective maximum transmit powers associated with the one or more SRS ports, and determine, based on the power headroom report, respective maximum transmit powers associated with one or more remaining SRS ports of the set of SRS ports are applied to the one or more SRSs transmitted using the one or more remaining SRS ports based on respective transmit powers associated with the one or more remaining SRS ports exceeding the respective maximum transmit powers associated with the one or more remaining SRS ports. Additionally, or alternatively, the processor 800 may be configured to or operable to support any one or combination of to obtain an estimation of a channel corresponding to the one or more SRSs based on at least one of the respective transmit powers associated with the one or more SRS ports or the respective maximum transmit powers associated with the one or more remaining SRS ports.

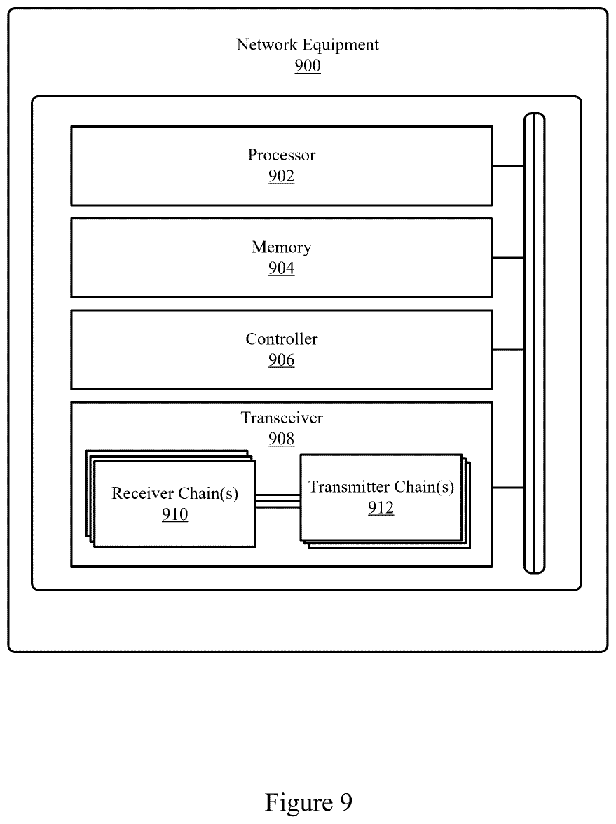

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support means for receiving a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports, and receiving, based on the power headroom report, one or more SRSs corresponding to the set of SRS ports.

Additionally, the NE 900 may be configured to or operable to support any one or combination of respective transmit powers associated with the set of SRS ports correspond to respective differences in insertion losses between the SRS port and respective additional SRS ports of the set of SRS ports up to respective maximum transmit powers associated with the set of SRS ports, where the power headroom report includes a power headroom associated with the SRS port. Additionally, or alternatively, the NE 900 may be configured to or operable to support any one or combination of the transmit power threshold is based on an additional SRS port of the set of SRS ports, where the additional SRS port is associated with a largest insertion loss of the respective insertion losses associated with the set of SRS ports. Additionally, or alternatively, the NE 900 may be configured to or operable to support any one or combination of to receive, prior to the power headroom report, signaling that indicates at least one of first respective differences in insertion loss between the set of SRS ports or second respective differences in insertion losses corresponding to the set of SRS ports relative to the SRS port.

Additionally, or alternatively, the NE 900 may be configured to or operable to support any one or combination of to transmit, to a UE and prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. Additionally, or alternatively, to receive the power headroom report, the NE 900 may be configured to or operable to support any one or combination of to receive signaling including the power headroom report for the SRS port and additional information including the maximum transmit power associated with the SRS port.

Additionally, or alternatively, to receive the power headroom report, the NE 900 may be configured to or operable to support any one or combination of to receive, in an uplink control channel, dedicated signaling including the power headroom report. Additionally, or alternatively, to receive the one or more SRSs, the NE 900 may be configured to or operable to support any one or combination of to determine, based on the power headroom report, respective transmit powers associated with one or more SRS ports of the set of SRS ports applied to the one or more SRSs transmitted using the one or more SRS ports of the set of SRS ports, where the respective transmit powers associated with the one or more SRS ports include values up to respective maximum transmit powers associated with the one or more SRS ports, and determine, based on the power headroom report, respective maximum transmit powers associated with one or more remaining SRS ports of the set of SRS ports are applied to the one or more SRSs transmitted using the one or more remaining SRS ports based on respective transmit powers associated with the one or more remaining SRS ports exceeding the respective maximum transmit powers associated with the one or more remaining SRS ports. Additionally, or alternatively, the NE 900 may be configured to or operable to support any one or combination of to obtain an estimation of a channel corresponding to the one or more SRSs based on at least one of the respective transmit powers associated with the one or more SRS ports or the respective maximum transmit powers associated with the one or more remaining SRS ports.

Additionally, or alternatively, the NE 900 may support at least one memory (e.g., the memory 904) and at least one processor (e.g., the processor 902) coupled with the at least one memory and configured to cause the NE to receive a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports, and receive, based on the power headroom report, one or more SRSs corresponding to the set of SRS ports.

Additionally, the NE 900 may be configured to support any one or combination of respective transmit powers associated with the set of SRS ports correspond to respective differences in insertion losses between the SRS port and respective additional SRS ports of the set of SRS ports up to respective maximum transmit powers associated with the set of SRS ports. Additionally, or alternatively, the NE 900 may be configured to support any one or combination of the power headroom report includes a power headroom associated with the SRS port, where the transmit power threshold is based on an additional SRS port of the set of SRS ports, where the additional SRS port is associated with a largest insertion loss of the respective insertion losses associated with the set of SRS ports. Additionally, or alternatively, the NE 900 may be configured to support any one or combination of to receive, prior to the power headroom report, signaling that indicates at least one of first respective differences in insertion loss between the set of SRS ports or second respective differences in insertion losses corresponding to the set of SRS ports relative to the SRS port.

Additionally, or alternatively, the NE 900 may be configured to support any one or combination of to transmit, to a UE and prior to the power headroom report, signaling that indicates for the UE to transmit the power headroom report for the SRS port based on the transmit power associated with the SRS port satisfying the transmit power threshold, where the signaling allocates one or more time-frequency resources for the power headroom report. Additionally, or alternatively, to receive the power headroom report, the NE 900 may be configured to support any one or combination of to receive signaling including the power headroom report for the SRS port and additional information including the maximum transmit power associated with the SRS port. Additionally, or alternatively, to receive the power headroom report, the NE 900 may be configured to support any one or combination of to receive, in an uplink control channel, dedicated signaling including the power headroom report.

Additionally, or alternatively, to receive the one or more SRSs, the NE 900 may be configured to support any one or combination of to determine, based on the power headroom report, respective transmit powers associated with one or more SRS ports of the set of SRS ports applied to the one or more SRSs transmitted using the one or more SRS ports of the set of SRS ports, where the respective transmit powers associated with the one or more SRS ports include values up to respective maximum transmit powers associated with the one or more SRS ports, and determine, based on the power headroom report, respective maximum transmit powers associated with one or more remaining SRS ports of the set of SRS ports are applied to the one or more SRSs transmitted using the one or more remaining SRS ports based on respective transmit powers associated with the one or more remaining SRS ports exceeding the respective maximum transmit powers associated with the one or more remaining SRS ports. Additionally, or alternatively, the NE 900 may be configured to support any one or combination of to obtain an estimation of a channel corresponding to the one or more SRSs based on at least one of the respective transmit powers associated with the one or more SRS ports or the respective maximum transmit powers associated with the one or more remaining SRS ports.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., an LNA) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 912 may also include at least one PA configured to amplify the modulated signal to an appropriate power level suitable for transmission over the wireless medium. The transmitter chain 912 may also include one or more antennas for transmitting the amplified signal into the air or wireless medium.

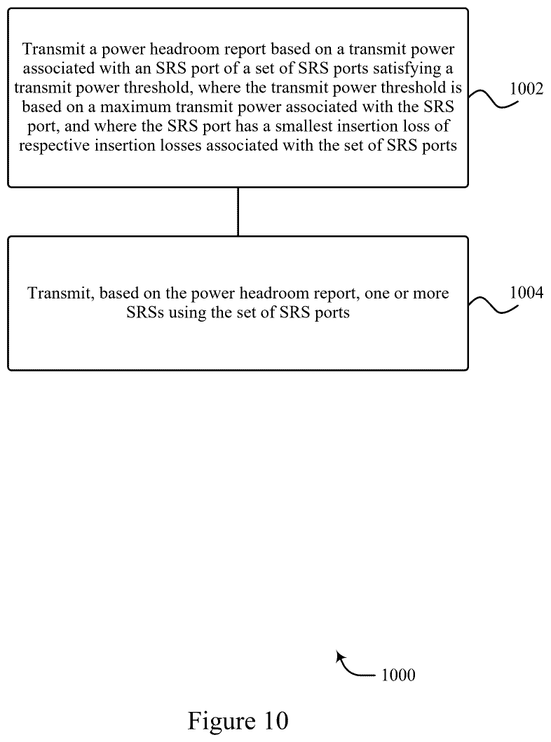

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include transmitting a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports. The operations of 1002 may be performed in accordance with examples as described herein. In some implementations, aspects of the operations of 1002 may be performed by a UE as described with reference to FIG. 7.

At 1004, the method may include transmitting, based on the power headroom report, one or more SRSs using the set of SRS ports. The operations of 1004 may be performed in accordance with examples as described herein. In some implementations, aspects of the operations of 1004 may be performed by a UE as described with reference to FIG. 7.

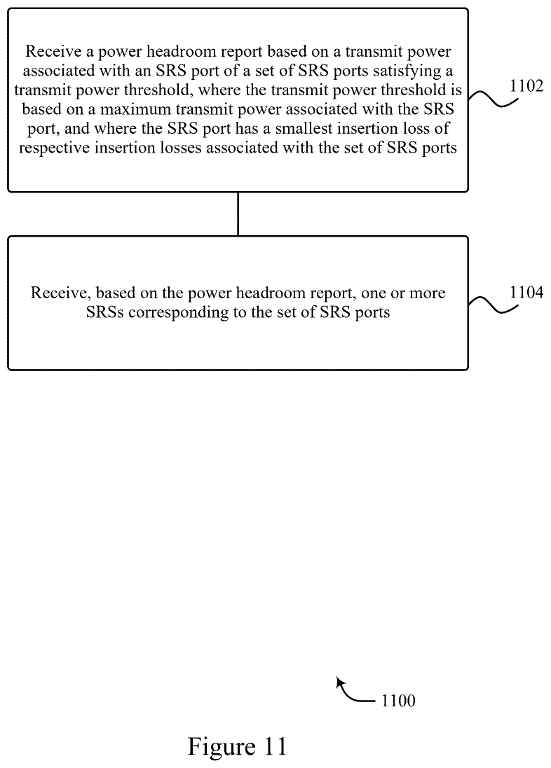

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include receiving a power headroom report based on a transmit power associated with an SRS port of a set of SRS ports satisfying a transmit power threshold, where the transmit power threshold is based on a maximum transmit power associated with the SRS port, and where the SRS port has a smallest insertion loss of respective insertion losses associated with the set of SRS ports. The operations of 1102 may be performed in accordance with examples as described herein. In some implementations, aspects of the operations of 1102 may be performed by an NE as described with reference to FIG. 9.

At 1104, the method may include receiving, based on the power headroom report, one or more SRSs corresponding to the set of SRS ports. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a power headroom report based at least in part on a transmit power associated with a sounding reference signal (SRS) port of a plurality of SRS ports satisfying a transmit power threshold, wherein the transmit power threshold is based at least in part on a maximum transmit power associated with the SRS port, and wherein the SRS port has a smallest insertion loss of respective insertion losses associated with the plurality of SRS ports; and
transmit, based at least in part on the power headroom report, one or more SRSs using the plurality of SRS ports.

2. The UE of claim 1, wherein respective transmit powers associated with the plurality of SRS ports correspond to respective differences in insertion losses between the SRS port and respective additional SRS ports of the plurality of SRS ports up to respective maximum transmit powers associated with the plurality of SRS ports, wherein the power headroom report comprises a power headroom associated with the SRS port.

3. The UE of claim 2, wherein the transmit power threshold is based at least in part on an additional SRS port of the plurality of SRS ports, and wherein the additional SRS port is associated with a largest insertion loss of the respective insertion losses associated with the plurality of SRS ports.

4. The UE of claim 2, wherein the at least one processor is further operable to cause the UE to transmit, prior to the power headroom report, signaling that indicates at least one of first respective differences in insertion loss between the plurality of SRS ports or second respective differences in insertion losses corresponding to the plurality of SRS ports relative to the SRS port.

5. The UE of claim 1, wherein the at least one processor is further operable to cause the UE to receive, prior to the power headroom report, signaling that indicates for the UE to transmit the power headroom report for the SRS port based at least in part on the transmit power associated with the SRS port satisfying the transmit power threshold, wherein the signaling allocates one or more time-frequency resources for the power headroom report.

6. The UE of claim 1, wherein to transmit the power headroom report, the at least one processor is operable to cause the UE to transmit signaling comprising the power headroom report for the SRS port and additional information comprising the maximum transmit power associated with the SRS port.

7. The UE of claim 1, wherein to transmit the power headroom report, the at least one processor is operable to cause the UE to transmit, in an uplink control channel, dedicated signaling comprising the power headroom report.

8. The UE of claim 1, wherein to transmit the one or more SRSs, the at least one processor is operable to cause the UE to:
apply respective transmit powers associated with one or more SRS ports of the plurality of SRS ports to the one or more SRSs transmitted using the one or more SRS ports, wherein the respective transmit powers associated with the one or more SRS ports comprise values up to respective maximum transmit powers associated with the one or more SRS ports; and
apply respective maximum transmit powers associated with one or more remaining SRS ports of the plurality of SRS ports to the one or more SRSs transmitted using the one or more remaining SRS ports based at least in part on respective transmit powers associated with the one or more remaining SRS ports exceeding the respective maximum transmit powers associated with the one or more remaining SRS ports.

9. The UE of claim 8, wherein an estimation of a channel corresponding to the one or more SRSs is based at least in part on applying at least one of the respective transmit powers associated with the one or more SRS ports or the respective maximum transmit powers associated with the one or more remaining SRS ports.

10. A method performed by a user equipment (UE), the method comprising:
transmitting a power headroom report based at least in part on a transmit power associated with a sounding reference signal (SRS) port of a plurality of SRS ports satisfying a transmit power threshold, wherein the transmit power threshold is based at least in part on a maximum transmit power associated with the SRS port, and wherein the SRS port has a smallest insertion loss of respective insertion losses associated with the plurality of SRS ports; and
transmitting, based at least in part on the power headroom report, one or more SRSs using the plurality of SRS ports.

11. A network equipment (NE) for wireless communication, comprising:
at least one memory; and
at least one processor coupled with the at least one memory and operable to cause the NE to:
receive a power headroom report based at least in part on a transmit power associated with a sounding reference signal (SRS) port of a plurality of SRS ports satisfying a transmit power threshold, wherein the transmit power threshold is based at least in part on a maximum transmit power associated with the SRS port, and wherein the SRS port has a smallest insertion loss of respective insertion losses associated with the plurality of SRS ports; and
receive, based at least in part on the power headroom report, one or more SRSs corresponding to the plurality of SRS ports.

12. The NE of claim 11, wherein respective transmit powers associated with the plurality of SRS ports correspond to respective differences in insertion losses between the SRS port and respective additional SRS ports of the plurality of SRS ports up to respective maximum transmit powers associated with the plurality of SRS ports, wherein the power headroom report comprises a power headroom associated with the SRS port.

13. The NE of claim 12, wherein the transmit power threshold is based at least in part on an additional SRS port of the plurality of SRS ports, and wherein the additional SRS port is associated with a largest insertion loss of the respective insertion losses associated with the plurality of SRS ports.

14. The NE of claim 12, wherein the at least one processor is further operable to cause the NE to receive, prior to the power headroom report, signaling that indicates at least one of first respective differences in insertion loss between the plurality of SRS ports or second respective differences in insertion losses corresponding to the plurality of SRS ports relative to the SRS port.

15. The NE of claim 11, wherein the at least one processor is further operable to cause the NE to transmit, to a user equipment (UE) and prior to the power headroom report, signaling that indicates for the UE to transmit the power headroom report for the SRS port based at least in part on the transmit power associated with the SRS port satisfying the transmit power threshold, wherein the signaling allocates one or more time-frequency resources for the power headroom report.

16. The NE of claim 11, wherein to receive the power headroom report, the at least one processor is operable to cause the NE to receive signaling comprising the power headroom report for the SRS port and additional information comprising the maximum transmit power associated with the SRS port.

17. The NE of claim 11, wherein to receive the power headroom report, the at least one processor is operable to cause the NE to receive, in an uplink control channel, dedicated signaling comprising the power headroom report.

18. The NE of claim 11, wherein to receive the one or more SRSs, the at least one processor is operable to cause the NE to:
determine, based at least in part on the power headroom report, respective transmit powers associated with one or more SRS ports of the plurality of SRS ports applied to the one or more SRSs transmitted using the one or more SRS ports of the plurality of SRS ports, wherein the respective transmit powers associated with the one or more SRS ports comprise values up to respective maximum transmit powers associated with the one or more SRS ports; and
determine, based at least in part on the power headroom report, respective maximum transmit powers associated with one or more remaining SRS ports of the plurality of SRS ports are applied to the one or more SRSs transmitted using the one or more remaining SRS ports based at least in part on respective transmit powers associated with the one or more remaining SRS ports exceeding the respective maximum transmit powers associated with the one or more remaining SRS ports.

19. The NE of claim 18, wherein the at least one processor is further operable to cause the NE to obtain an estimation of a channel corresponding to the one or more SRSs based at least in part on at least one of the respective transmit powers associated with the one or more SRS ports or the respective maximum transmit powers associated with the one or more remaining SRS ports.

20. A method performed by a network equipment (NE), the method comprising:
receiving a power headroom report based at least in part on a transmit power associated with a sounding reference signal (SRS) port of a plurality of SRS ports satisfying a transmit power threshold, wherein the transmit power threshold is based at least in part on a maximum transmit power associated with the SRS port, and wherein the SRS port has a smallest insertion loss of respective insertion losses associated with the plurality of SRS ports; and
receiving, based at least in part on the power headroom report, one or more SRSs corresponding to the plurality of SRS ports.
